(19) United States
(12) Patent Application Publication
(10) Pub. No.: US 2006/0225550 A1
(43) Pub. Date: Oct. 12, 2006

(54) Control system method of operation for electric power tools

(76) Inventors: Sam Walters, Buford, GA (US); Michael S. Powell, Boca Raton, FL (US)

Correspondence Address: Mark D. Bowen;Stearns Weaver Miller, et al., Suite 2100, 200 East Las Olas Boulevard, Fort Lauderdale, FL, 33301, US

(21) Appl. No.: 11/385,067

(22) Filed: Mar. 21, 2006

Related U.S. Application Data
(63) Continuation-in-part of application No. 10/930,928, filed on Aug. 31, 2004, now Pat. No. 7,044,039.
(63) Continuation-in-part of application No. 10/993,689, filed on Nov. 19, 2004.

(51) Int. Cl. B23D 45/02

(52) U.S. Cl. 83/70; 83/100; 83/485

(57) ABSTRACT

A control system for electric power tools to automatically control the operation of the machine and related systems. The control system includes a keypad for restricting operation of the machine to authorized users armed with knowledge of assigned access codes, while providing automated control of various machine components and systems. The system further includes electrical power output control for controlling power supplied to the machine and associated systems, a timer to limit operating time, and audio/visual warning beacons. Upon entering a security code, the control system functions to activate the machine by providing electrical power to any primary and secondary electric motors, lighting systems, power supply outlets, dust collection systems, and audio or visual safety warning systems. An internal timer disconnects the electrical power supply after a predetermined amount of time, e.g. 5 minutes, thereby insuring that the machine is not inadvertently left on.

### CROSS REFERENCE TO RELATED APPLICATIONS

This application is a continuation-in-part of U.S. patent application Ser. No. 10/930,928, filed on Aug. 31, 2004, and a continuation-in-part of U.S. patent application Ser. No. 10/993,689, filed Nov. 19, 2004.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to the control of electric power tools, and more particularly to control panels for use in safe operation of electric power tools, such as radial arm saws, panel saws, pipe cutters and the like.

2. Description of Related Art

Over the past several years, the use of electric power tools has increased significantly due largely to versatility and simplicity of use. Today, many home improvement stores have a variety of electric power tools installed in retail space locations accessible for use by floor employees and the public. The risk of injury increases when the saw is used by inexperienced operators in garage shops or customers and/or employees in retail locations. A serious problem present with the widespread use of electric power tools relates to ease of use and operator safety. More particularly, commercial grade electric power tools can be complex and difficult to operate. In addition, tools installed in retail home improvement centers are often operated by store employees having little or no training or experience in the operation of the device, or even store shoppers having no training. As used herein, “power tools” and “power tool machines” shall include without limitation, panel saws, radial arm saws, pipe threaders, and tile cutters. Accordingly, there exists a need for a control system that restricts use of electric power tool machines to authorized users, while simplifying operation, control, and use.

### BRIEF SUMMARY OF THE INVENTION

The present invention overcomes the limitations and disadvantages in the art by providing an improved control system for power tool machines. A control system in accordance with the present invention, includes a keypad for restricting operation of the machine to authorized users armed with knowledge of assigned access codes, while providing automated control of various machine components and systems. In a preferred embodiment, a power tool machine is adapted with a control system that functions to automatically control the operation of the machine and related systems. The control system includes access control features, electrical power output control for controlling power supplied to the machine and associated systems, a timer to limit operating time, and audio/visual warning beacons. Upon entering a security code, the control system functions to activate the machine by providing electrical power to any primary and secondary electric motors, lighting systems, power supply outlets, dust collection systems, and audio or visual safety warning systems. An internal timer disconnects the electrical power supply after a predetermined amount of time, e.g. 5 minutes, thereby insuring that the machine is not inadvertently left on.

Accordingly, it is an object of the present invention to provide an improved control system for power tool machines that provides motor protection.

Yet another object of the present invention is to provide such a system wherein operation of the machine is restricted to authorized users.

Still another object of the present invention is to provide an improved control system wherein operation of the machine is subject to time limitation.

Yet another object of the present invention is to provide an improved control system for power tool machines that also functions to control secondary systems, such as duct collection systems.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a front view of a panel saw adapted with a control system in accordance with the present invention;

FIG. 2 is an electrical schematic for a control system in accordance with the present invention for use with a panel saw;

FIG. 3 is an electrical schematic for an alternate embodiment thereof incorporating communication capabilities;

FIG. 4 is a radial arm saw adapted with a control system in accordance with the present invention;

FIG. 5 is a detailed view of the radial arm saw control panel;

FIG. 6 is an electrical schematic for a control system in accordance with the present invention for use with a radial arm saw;

FIG. 7 is an electrical schematic for an alternate embodiment thereof incorporating communication capabilities;

FIG. 8 is an electrical schematic for power wiring for the radial arm saw panel;

FIG. 9 is an alternate electrical schematic for power wiring for an alternate embodiment radial arm saw;

FIG. 10 is an electrical schematic for a DC control system in accordance with the present invention for use with a pipe threader; and

FIG. 11 is an electrical schematic for a control system in accordance with the present invention for use with a tile cutter.

### DETAILED DESCRIPTION OF THE INVENTION

The present invention provides an improved control system and method for use in controlling electric power tools. The system and methods associated with the present invention will now be described in connection with several electrically powered tools.

I. Panel Saw

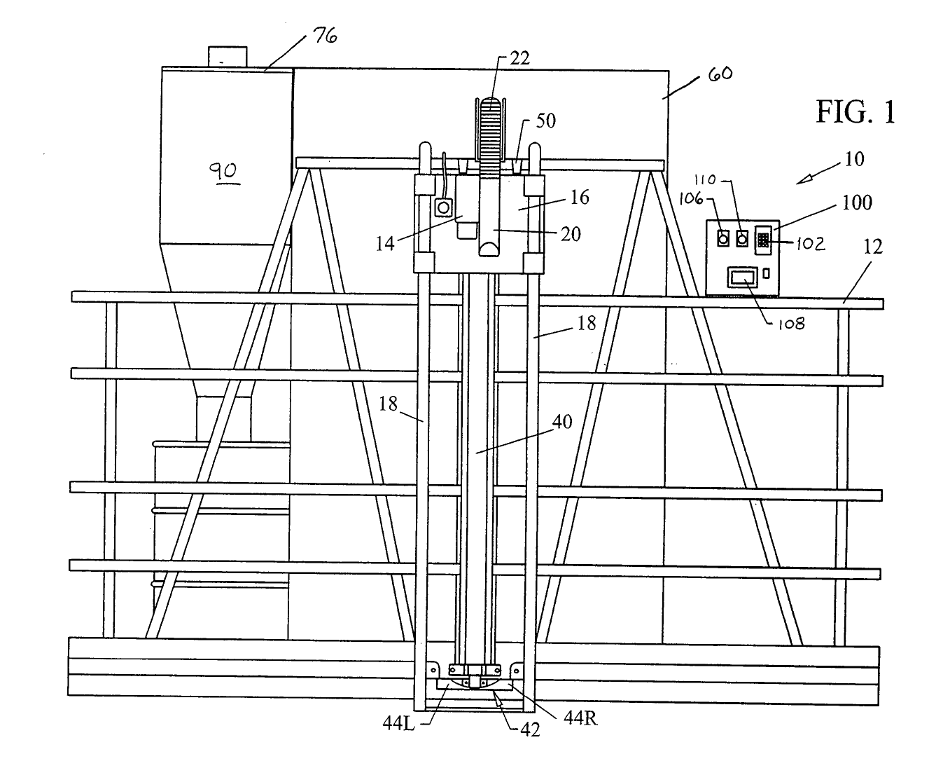

In a first embodiment illustrated in FIG. 1, the present invention is adapted for use with an electrically powered panel saw, generally referenced as 10. A control panel, referenced as 100 which functions to provide safe and efficient operation of panel saw 10, particularly for such a saw operating in retail store environments, such as saws operating in home improvement and hardware stores, as shown in FIG. 1. Control panel 100 provides a primary power inlet connection connection to electrical power, such as 120VAC or 230 VAC electrical power and includes a step-down electrical transformer capable of 24 VAC output. The ability of control panel 100 to operate using multiple input voltages is considered important since the power available at different locations often varies. Control panel 100 includes a keypad 102 that provides an input device to restrict operation to authorized users who enter an appropriate authorization code. A power supply is connected to the 24 VAC output for providing DC power to keypad 102. In addition, a push-start/pull-stop control button 106 is provided to initiate or discontinue operation. Further, control panel 100 includes a visual alarm beacon 108 that is configured to flash when power is supplied to the panel saw systems, and an alarm horn 110 that is configured to generate an audible sound after a predetermined time period to indicate that the panel saw is about to shut down.

The operating sequence for a panel saw adapted with a control panel according to the present invention is a follows. A red indicator light on the keypad indicates that power is being supplied to the panel saw control panel. The user enters the appropriate security code on the keypad to initiate operation. As should be apparent, any suitable code may be used. Upon entry of the appropriate code, a light on control button 106 illuminates indicating that a predetermined operation period, such as five minutes, has begun. The user then must pull control button 106 to automatically supply power from the control panel to the panel saw and dust collection system, at which time beacon 108 is activated thus providing a visual signal/warning that power has been supplied and the systems are operational. Shortly before expiration of the predetermined operation period (e.g. 30 seconds prior to expiration) alarm horn 110 sounds as a signal that the saw will automatically shut down shortly. While the system is programmed to allow operation for a predetermined period of time before automatically shutting down, the period of operation may be extended by re-entering the authorization code. If, at any time, the operator wishes to manually shut the systems down he simply must push control button 106.

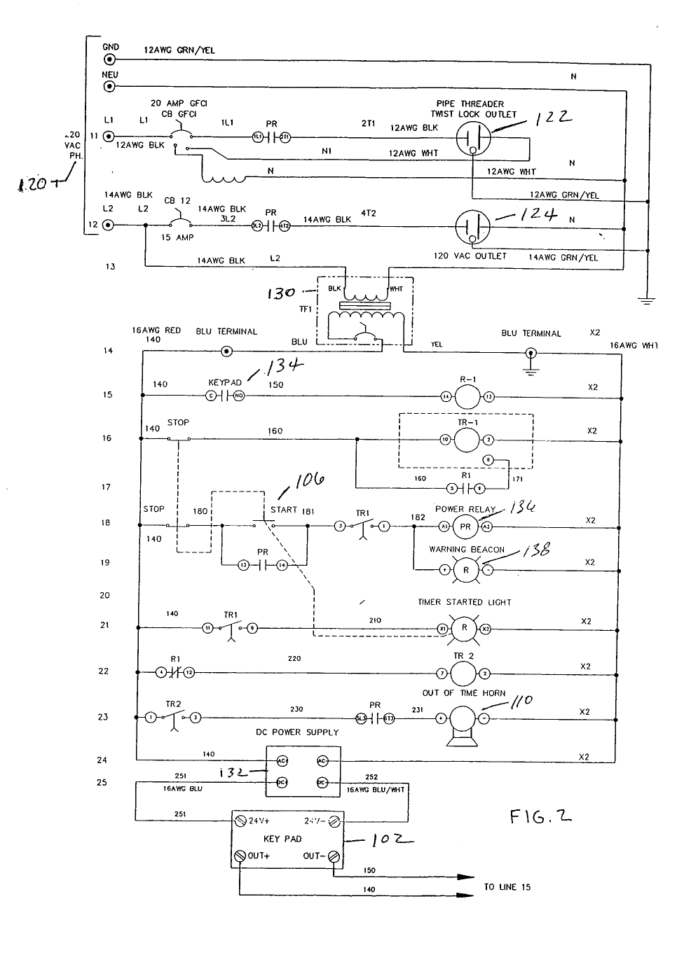

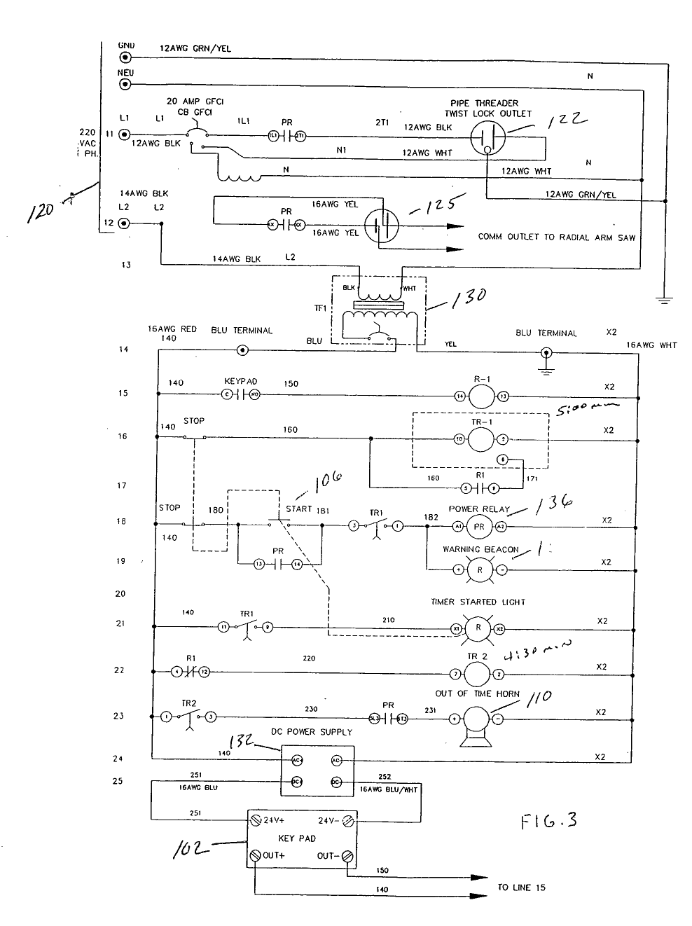

FIG. 2 is an electrical schematic of wiring for control panel 100 for a panel saw, and FIG. 3 is the electrical schematic shown in FIG. 2 with additional communication wiring for use with an alternate embodiment panel saw. As best seen in FIG. 2, control panel 100 is provided with electrical power from a suitable 220 VAC, single phase source, at electrical power input terminal 120. Two power outlets are in electrical communication with power input terminal 120, namely 120 VAC outlets 122 and 124, for use in supplying power to auxiliary devices. Outlet 122 is provided to supply power to a pipe threader in an alternate installation configuration, and outlet 124 is available to provide 120 VAC power for an auxiliary dust collection system. As illustrated in FIG. 3, in an alternate embodiment a communication outlet 125 provides a clean set of contacts for activating an auxiliary device.

An electrical transformer 130 has an input in electrical communication with power input 120 and an output adapted for reducing the voltage to 24 VAC for use by other control system components. In addition a DC power supply 132 is provided 24 VAC power and converts the power to 24 VDC for supply to keypad 102. As noted above, use of the panel saw requires entry of an authorization code via keypad 102. Upon entry of the correct code, keypad 102 sends a signal to close a switch 134 thereby providing power to illuminate a start/stop button 106. This indicates that a predetermined operating time period (e.g 5 minutes) has begun. The user then must pull control button 106 to automatically supply power from the control panel to the panel saw and dust collection system, at which time a warning beacon relay 138 activates warning beacon 108 thus providing a visual signal/warning that power has been supplied and the systems are operational. A power relay 136 controls power to the panel saw motor.

Shortly before expiration of the predetermined operation period (e.g. 30 seconds prior to expiration) alarm horn 110 sounds as a signal that the saw will automatically shut down shortly. While the system is programmed to allow operation for a predetermined period of time before automatically shutting down, the period of operation may be extended by re-entering the authorization code. If, at any time, the operator wishes to manually shut the systems down he simply must push control button 106.

II. Radial Arm Saw

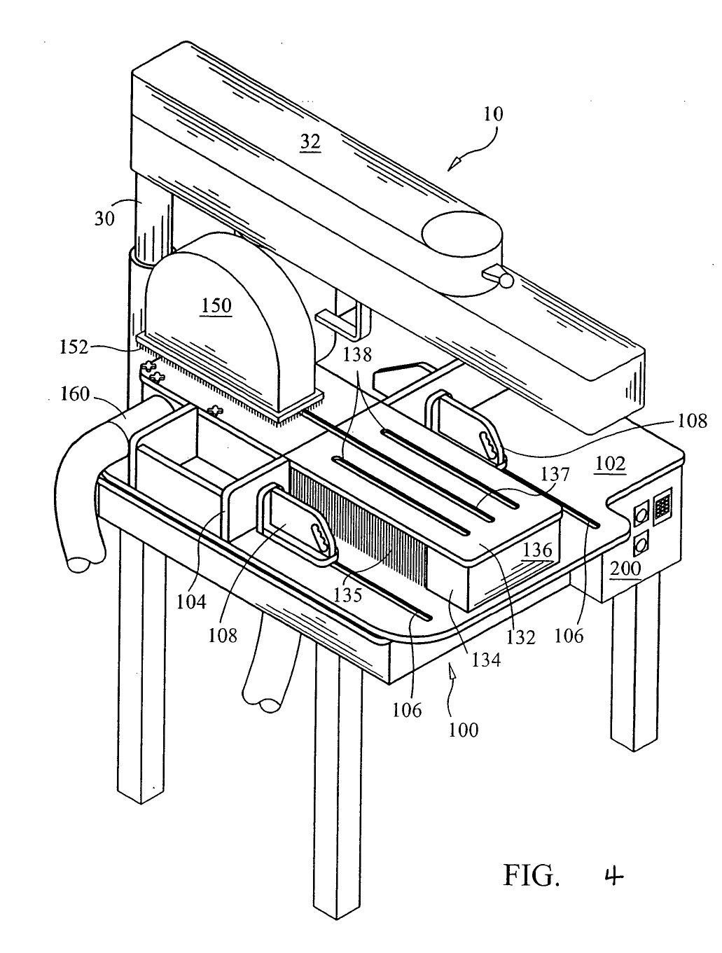

As best depicted in FIGS. 4-9, the present invention is further adaptable to control an electrically powered radial arm saw. In this embodiment a control panel, referenced as 200, functions to provide safe and efficient operation of the radial arm saw, particularly for saws operating in retail store environments, such as saws operating in home improvement and hardware stores. Control panel 200 provides a primary connection to electrical power, such as 208VAC, 230 VAC, or 480VAC electrical power and includes a step-down electrical transformer capable of 24 VAC output. The ability of control panel 200 to operate using a range of voltages is considered important since the power available at different locations often varies. Control panel 200 includes a keypad 202 that provides an input device to restrict operation to authorized users who enter an appropriate authorization code. A power supply is connected to the 24 VAC output for providing DC power to keypad 202. Control panel 200 further includes a main disconnect switch 204 that enables quick disconnection of power to the saw and various components. In addition, a push-start/pull-stop control button 206 is provided to initiate or discontinue operation. Further, control panel 200 includes a visual alarm beacon 208 that is configured to flash when power is supplied to the radial arm saw systems, and an alarm horn 210 that is configured to generate an audible sound after a predetermined time period to indicate that the radial arm saw is about to shut down.

The operating sequence for a radial arm saw adapted with a control panel according to the present invention is a follows. A red indicator light on the keypad indicates that power is being supplied to the radial arm saw control panel. The user enters the appropriate security code on the keypad to initiate operation. As should be apparent, any suitable code may be used. Upon entry of the appropriate code, a light on control button 206 illuminates indicating that a predetermined operation period, such as five minutes, has begun. The user then must pull control button 206 to automatically supply power from the control panel to the radial arm saw and dust collection system, at which time beacon 208 is activated thus providing a visual signal/warning that power has been supplied and the systems are operational. Shortly before expiration of the predetermined operation period (e.g. 30 seconds prior to expiration) alarm horn 210 sounds as a signal that the saw will automatically shut down shortly. While the system is programmed to allow operation for a predetermined period of time before automatically shutting down, the period of operation may be extended by re-entering the authorization code. If, at any time, the operator wishes to manually shut the systems down he simply must push control button 206.

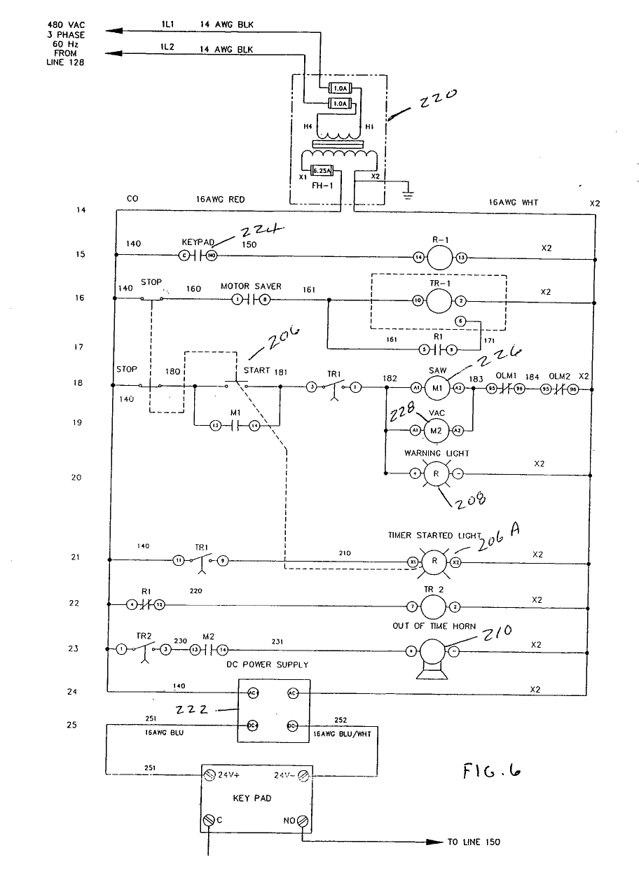

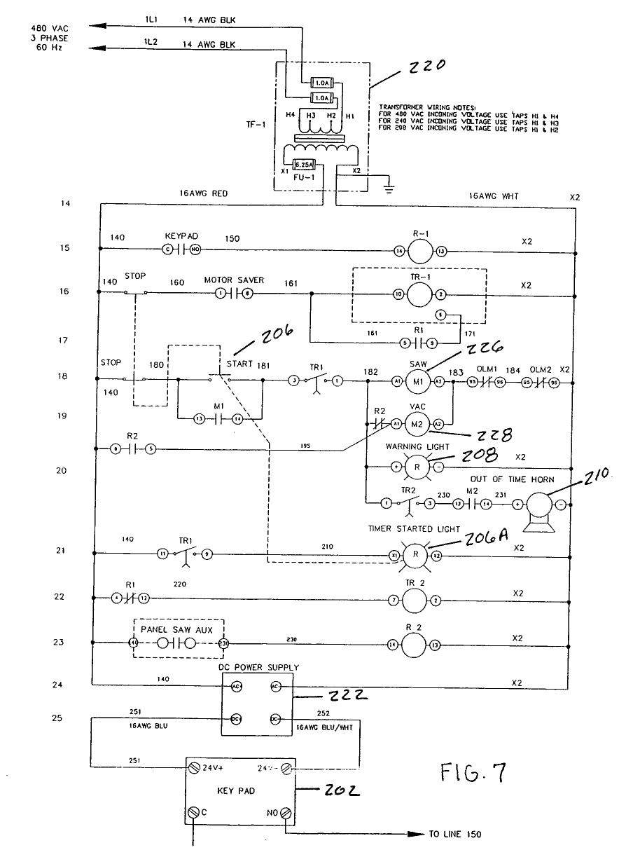

FIG. 6 is an electrical schematic of the radial arm saw control panel control wiring, and FIG. 7 is an electrical schematic of the radial arm saw control panel control wiring for an alternate embodiment. As best depicted in FIGS. 6 and 7, control panel 200 is preferably supplied with 480 VAC 3-phase power. The power is supplied to an electrical transformer 220 that reduces the voltage to 24 VAC to power other control system components. In addition, a DC power supply 222 has an input in communication with the 24VAC power and an output delivering 24VDC power. Keypad 202 is in electrical communication with the output of DC power supply 222. As noted above, operation of the radial arm saw system requires entry of an authorization code via keypad 202. Upon entry of the correct code, keypad 202 sends a signal to close switch 224 and provides power to illuminate a light 206A on start/stop button 206. The illumination of stop/start button indicates that a predetermined operating time period (e.g. 5 minutes) has begun. When the user activates (e.g. pulls) the start/stop button power is supplied to the radial arm saw and associated dust collection system by relays 226 and 228 respectively, and a visual warning beacon 208 starts flashing thus providing a visual signal/warning that power has been supplied and the systems are operational.

Shortly before expiration of the predetermined operation period (e.g. 30 seconds prior to expiration) alarm horn 210 sounds thus giving an audible indication that the system will automatically shut down shortly. While the system is programmed to allow operation for a predetermined period of time before automatically shutting down, the period of operation may be extended by re-entering the authorization code. If, at any time, the operator wishes to manually shut the systems down, the operator may terminate operation using start/stop button 206.

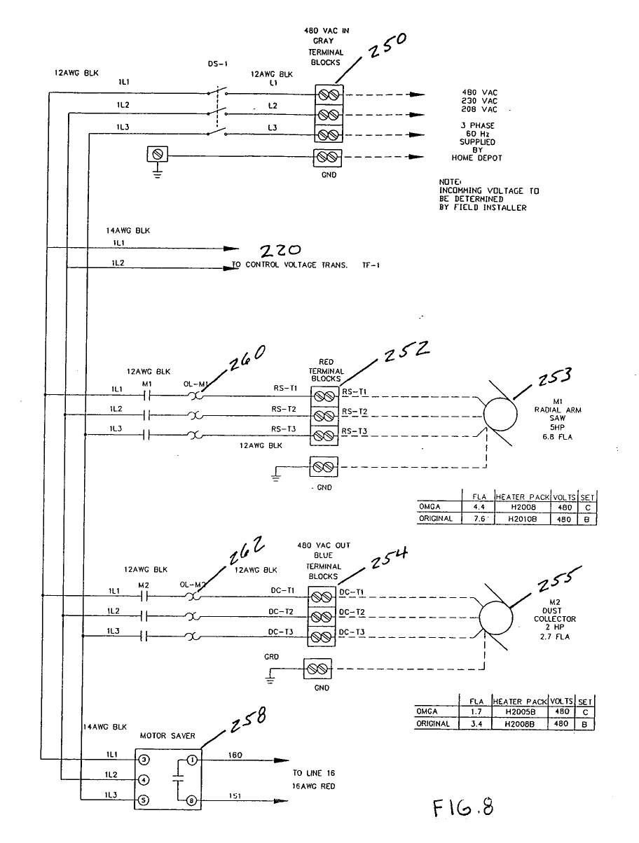

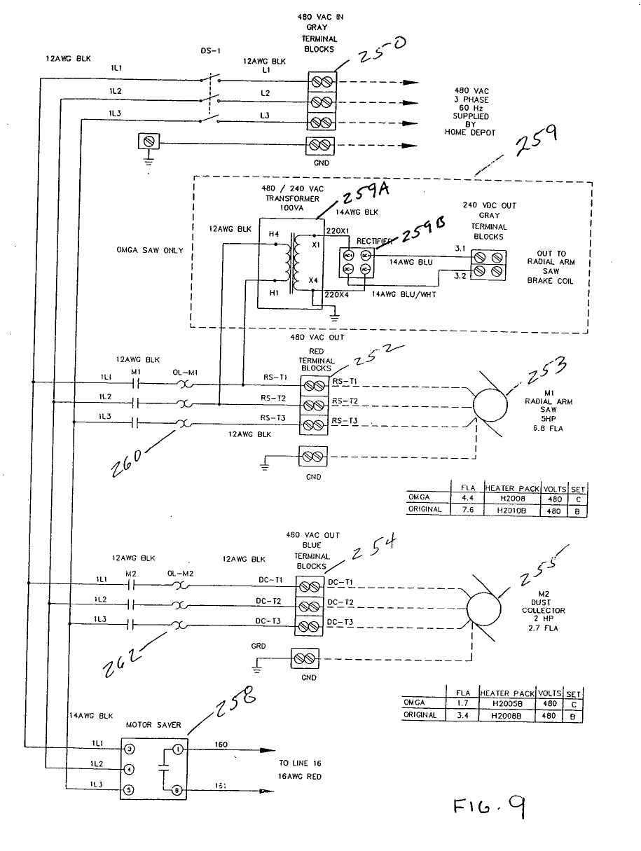

FIGS. 8 and 9 are power wiring schematics for the radial arm saw. FIG. 8 is a power wiring schematic for a typical radial arm saw, and FIG. 9 is a power wiring schematic for a radial arm saw that requires a separate power supply for a saw brake. In either embodiment, the power wiring includes a main power input terminal block 250, preferably adapted for connection to a 208/230/480 VAC, 3-phase power source. In addition, the system includes a radial arm saw terminal block 252 for providing power to the radial arm saw motor 253, and a dust collector terminal block 254 for providing power to a dust collection system motor 255. FIG. 9 further illustrates an additional electrical connection, generally referenced as 259, for use with a radial arm saw having an electrically actuated saw brake coil. In this embodiment, a step-down transformer 259A reduces the 480 VAC line voltage to 240VAC, and a rectifier 259B converts the 240 VAC to 240VDC, which voltage is delivered to the radial arm saw brake coil. Accordingly, any disruption of the 480 VAC primary line voltage supplied to the radial arm saw motor at terminal block 252 will result in the engagement of the radial arm saw brake thus promptly stopping rotation of the radial arm saw blade.

A further significant aspect of the present invention involves adapting the power supply to the power tool motors with motor protection devices. More particularly, the present invention incorporates re-settable overload fuses 260 and 262 on the power supply for the terminal blocks, 252 and 254, that provide power to the radial arm saw motor 253 and dust collector motor 255. The overload fuses trip in over amperage conditions thereby terminating power supply to motors 253 and 255. In addition, the present invention incorporates a phase-loss monitor 258 that protects motors 253 and 255 from a phase loss power condition.

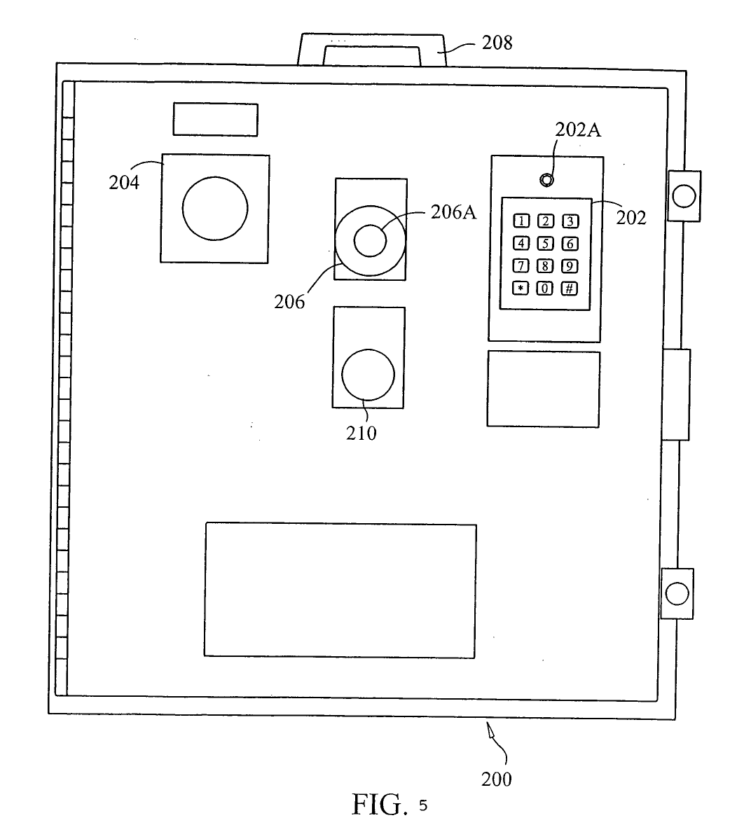

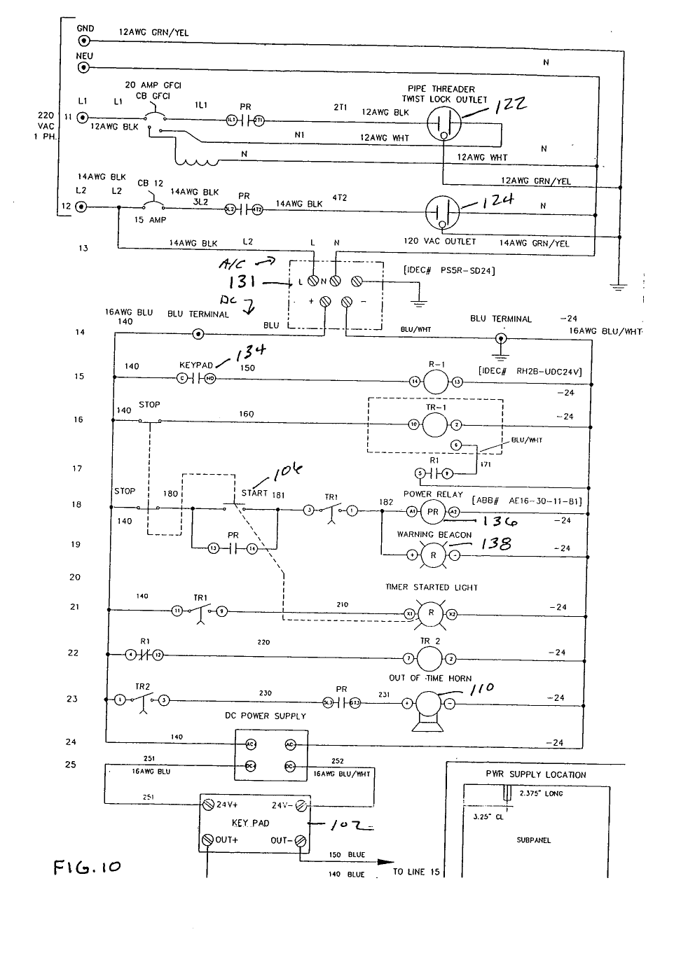

III. Pipe Threader FIG. 10 is an electrical schematic of a control system in accordance with the present invention adapted for use with a pipe threader. A control panel 100 as depicted in FIG. 5 functions as a user interface to provide safe and efficient operation of the pipe threader, particularly for a pipe threader installed in a retail store environments, such as home improvement and hardware stores. The functionality and operating sequence of the control panel is as described herein above. The electrical schematic embodiment depicted in FIG. 10 differs somewhat from the previously disclosed embodiments in that most of the control components are supplied with clean DC power. Providing the control components with DC power avoids contactor malfunction resulting from drop in voltage due to high lock rotor amperage requirements of the pipe threader motor.

FIG. 10 is an electrical schematic of wiring for control panel 100 for a pipe threader. As best seen in FIG. 10, control panel 100 is provided with electrical power from a suitable 220 VAC, single-phase source, at power input terminal 120. Two power outlets are in electrical communication with power input terminal 120, namely 120 VAC outlets 122 and 124. Power terminal 122 provides primary electrical power to the pipe threader, and outlet 124 is available to provide 120 VAC power for auxiliary use.

An electrical DC power supply 131 has an input in electrical communication with power input 120 and an output adapted for reducing and rectifying the voltage to 24 VDC for use by other control system components. In addition DC power is provided for supply to keypad 102. As noted above, use of the pipe threader requires entry of an authorization code via keypad 102. Upon entry of the correct code, keypad 102 sends a signal to close a switch 134 thereby providing power to illuminate a start/stop button 106. This indicates that a predetermined operating time period (e.g 5 minutes) has begun. The user then must pull control button 106 to automatically supply power from the control panel to the pipe threader and dust collection system, at which time a warning beacon relay 138 activates warning beacon 108 thus providing a visual signal/warning that power has been supplied and the systems are operational. A power relay 136 controls power to the pipe threader motor.

Shortly before expiration of the predetermined operation period (e.g. 30 seconds prior to expiration) alarm horn 110 sounds as a signal that the saw will automatically shut down shortly. While the system is programmed to allow operation for a predetermined period of time before automatically shutting down, the period of operation may be extended by re-entering the authorization code. If, at any time, the operator wishes to manually shut the systems down he simply must push control button 106.

IV. Tile Cutter

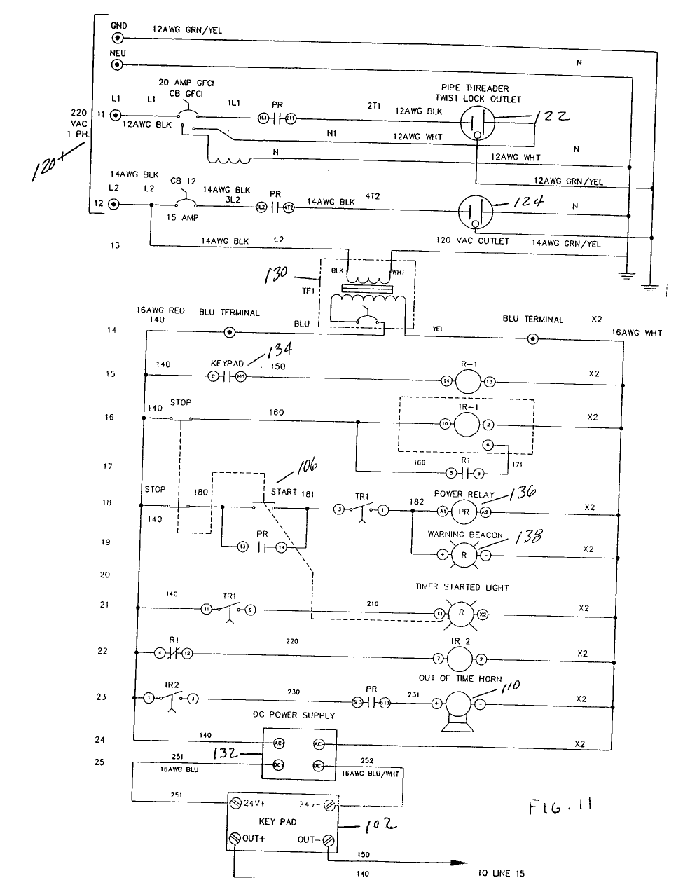

FIG. 11 is an electrical schematic of a control system in accordance with the present invention adapted for use with a tile cutter. A control panel 100 as depicted in FIG. 5 functions as a user interface to provide safe and efficient operation of the tile cutter, particularly for a tile cutter installed in a retail store environments, such as home improvement and hardware stores. The functionality and operating sequence of the control panel is as described herein above.

FIG. 11 is an electrical schematic of wiring for control panel 100 for a tile cutter. Control panel 100 is provided with electrical power from a suitable 220 VAC, single phase source, at power input terminal 120. Two power outlets are in electrical communication with power input terminal 120, namely 120 VAC outlets 122 and 124. Power terminal 122 provides primary electrical power to the tile cutter, and outlet 124 is available to provide 120 VAC power for auxiliary use.

An electrical transformer 130 has an input in electrical communication with power input 120 and an output adapted for reducing the voltage to 24 VAC for use by other control system components. In addition a DC power supply 132 is provided 24 VAC power and converts the power to 24 VDC for supply to keypad 102. As noted above, use of the tile cutter requires entry of an authorization code via keypad 102. Upon entry of the correct code, keypad 102 sends a signal to close a switch 134 thereby providing power to illuminate a start/stop button 106. This indicates that a predetermined operating time period (e.g 5 minutes) has begun. The user then must pull control button 106 to automatically supply power from the control panel to the tile cutter and an auxiliary outlet, at which time a warning beacon relay 138 activates warning beacon 108 thus providing a visual signal/warning that power has been supplied and the systems are operational. A power relay 136 controls power to the tile cutter motor.

Shortly before expiration of the predetermined operation period (e.g. 30 seconds prior to expiration) alarm horn 110 sounds as a signal that the tile cutter will automatically shut down shortly. While the system is programmed to allow operation for a predetermined period of time before automatically shutting down, the period of operation may be extended by re-entering the authorization code. If, at any time, the operator wishes to manually shut the systems down he simply must push control button 106.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A control system for an electric power tool adapted to selectively energize the power tool for a predetermined period of time upon entry of an authorization code, said control system comprising:
a control panel having an electrical power input electrically connected to an electrical power source, and an output electrically connected to the electric power tool;
means for selectively supplying electrical power to the electric power tool, including overload protection and phase-loss protection;
a timer adapted to cut-off the electrical power to the electric power tool after a predetermined period of operation;
a visual warning beacon adapted for activation when electrical power is supplied to the electric power tool;
an audible warning beacon adapted for activation prior to the expiration of said predetermined period of operation.

2. A control system for an electric power tool according to claim 1, wherein said means for selectively supplying electrical power to the electric power tool includes a keypad configured to energize a power supply circuit.

3. A control system for an electric power tool according to claim 2, wherein said power supply circuit includes a manual on/off switch configured to supply power to the electric power tool though said output when said power supply circuit is energized and said manual switch is configured to an “on” position.

4. A control system for an electric power tool according to claim 1, wherein said control panel further includes a second power output configured in parallel to provide power to an auxiliary system.

5. A control system for an electric power tool according to claim 4, wherein said auxiliary system comprises a dust collection system.

6. A control system for an electric power tool adapted to selectively energize the power tool for a predetermined period of time upon entry of an authorization code, said control system comprising:
a control panel having an electrical power input electrically connected to an electrical power source, and an electrical power supply circuit electrically connected to the electric power tool, said electrical power supply circuit including a fuse system for providing overload protection and a phase loss monitor to terminate power upon loss of an electrical phase;
said power supply circuit including a keypad adapted to energize said power supply circuit upon entry of a predetermined code;
said power supply circuit further including a manual switch having an “on” position and an “off” position, said manual switch electrically configured for supplying electric power to the electric power tool when said power supply circuit is energized and said manual switch is configured to said “on” position;
a timer adapted to initiate a timing cycle upon energizing of said power supply circuit and to de-energize said power supply circuit after a pre-determined time period;
a visual warning beacon adapted for activation when electrical power is supplied to the electric power tool;
an audible warning beacon adapted for activation prior to the expiration of said predetermined period of operation.

7. A control system for an electric power tool according to claim 6, wherein said control panel further includes a second power output configured in parallel to provide power to an auxiliary system.

8. A control system for an electric power tool according to claim 7, wherein said auxiliary system comprises a dust collection system.
